(19) United States
(12) Patent Application Publication
(10) Pub. No.: US 2007/0119762 A1
(43) Pub. Date: May 31, 2007

(54) Filtration device

(75) Inventors: Hsin Shao, Hsinchu (TW); Min-Chao Chang, Hsinchu City (TW); Ren-Yang Horng, Hsinchu (TW); Yih-Chang Chen, Hsinchu City (TW); Pi-Lien Hsiao, Hsinchu City (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/453,369

(22) Filed: Jun. 14, 2006

(30) Foreign Application Priority Data
Nov. 30, 2005 (TW) TW094142048

(51) Int. Cl. C02F 1/32; C02F 9/02; C02F 9/12

(52) U.S. Cl. 210/198.1; 210/205; 210/748; 210/220

(57) ABSTRACT

A filtration device. The filtration device includes a tank, photocatalyst, a light source and a non-woven membrane module. The tank includes a reacting section and a separating section. The photocatalyst is added to water. The light source, disposed in the reacting section, provides light to react with the photocatalyst and thereby decompose pollutants in the water. The non-woven membrane module, disposed in the separating section, intercepts the photocatalyst in the water, producing purified water.

### BACKGROUND OF THE INVENTION

1. Field of the Invention

The invention relates to filtration, and in particular, to a filtration device using photocatalyst to purify water.

2. Description of the Related Art

Photocatalyst has the ability to purify environments, with TiO₂ is the most used phtocatalyst. When water exists on the surface of photocatalyst (TiO₂) with sufficient light, Hydroxyl Radical (OH.) can be produced, then decomposing organic matter that attach to photocatalyst surface.

When utilizing photocatalyst in processing polluted water, the photocatalyst could be usually used in powder form, or fixed to carriers. A slurry photocatalyst reactor is used for powdered photocatalyst. The photocatalyst is suspended in the water. After the completion of the reaction using the powdered photocatalyst, the photocatalyst is recycled. But a carrier photocatalystic reactor is used for photocatalyst fixed to carriers. The selection of carrier material and the method of fixing photocatalyst are factors required.

Conventional recycling of photocatalyst uses ultra-filtration membrane or micro-filtration membrane, although both membranes of ultra-filtration or micro-filtration are microporous, resulting in high fabrication cost, high operating pressure, and complicated maintainance.

### BRIEF SUMMARY OF THE INVENTION

The invention provides a filtration device comprising a tank, photocatalyst, a light source and a non-woven membrane module. The tank comprises a reacting section and a separating section. The photocatalyst is added to water. The light source, disposed in the reacting section, provides light to react with the photocatalyst, decomposing pollutants in the water. The non-woven membrane module, disposed in the separating section, intercepts the photocatalyst in the water, purifying water.

The filtration device further comprises an inflow pump, communicating with the reacting section and pumping water into the tank, a first blower, providing air to the reacting section, and a first air distributor, disposed in the reacting section, communicating with the first blower. Air is diffused in the water by the first air distributor, uniformly suspending the photocatalyst.

The first blower comprises a manifold.

The filtration device further comprises a second air distributor, disposed in the separating section, communicating with the manifold, whereby air is diffused in the water, maintaining filtrating flux of the non-woven membrane module.

The filtration device further comprises a mixer, disposed in the reacting section, uniformly suspending the photocatalyst.

The filtration device further comprises a second blower, providing air to the separating section.

The filtration device further comprises a second air distributor, disposed in the separating section, communicating with the second blower or a manifold of the first blower, whereby air is diffused in the water, maintaining filtrating flux of the non-woven membrane module.

The photocatalyst is TiO₂ and is powdered.

The filtration device further comprises an outflow pump, communicated with the non-woven membrane module, removing out purified water, carriers, added to the reacting section and intercepting the photocatalyst.

The carriers are made of non-woven material.

The photocatalyst is pre-fixed in the carriers, and added to the reacting section.

The carriers are pervious to light.

The filtration device further comprises a sieve, disposed between the reacting section and the separating section, preventing the carriers from entering the separating section.

The diameter of the carriers is between 2 mm and 20 mm.

The carriers are of polymethyl methacrylate (PMMA), polystyrene (PS), polycarbonate (PC), polyethylene terephthalate (PET), polypropylene (PP), polyethylene (PE), 4-methylpentene (TPX), or a combination thereof.

The light has a wavelength between 250 nm and 450 nm.

The non-woven membrane module comprises a plurality of non-woven membrane, with pore size of diameter between 0.03 μm and 30 μm.

The non-woven membrane module comprises a plurality of non-woven membrane, and the non-woven membrane are of polymethyl methacrylate, polystyrene, polycarbonate, polyethylene terephthalate, polypropylene, polyethylene, 4-methylpentene, or a combination thereof.

The invention provides a variant filtration device, for purifying water, comprising a first tank, photocatalyst, a light source, a second tank, and a non-woven membrane module. The photocatalyst is added to the first tank. The light source, disposed in the first tank, provides light to react with the photocatalyst, decomposing pollutants in the water. The second tank, communicating with the first tank, receives water from the first tank. The non-woven membrane module, disposed in the second tank, intercepts the photocatalyst in the water, producing purified water.

The invention provides another variant filtration device, for purifying water, comprising a tank, photocatalyst, a light source, and a non-woven membrane module. The tank receives water to process water purification. The photocatalyst is added to the tank. The light source provides light to react with the photocatalyst, decomposing pollutant in the water. The non-woven membrane module, disposed under a waterline of the tank, intercepts the photocatalyst in the water, producing purified water.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a schematic view of a first embodiment of the invention;

FIG. 1B is a schematic view of a variant embodiment of the first embodiment of the invention;

FIG. 2 is a schematic view of a second embodiment of the invention;

FIG. 3 is a schematic view of a third embodiment of the invention.

### DETAILED DESCRIPTION OF THE INVENTION

The invention provides a filtration device, used after secondary or tertiary treatment, removing pollutant and sterilizing. The filtration device can further be used before processing raw water pretreatment, removing micro-contaminants, or in surface water and groundwater treatment, removing organic matter and nitrogen pollutants.

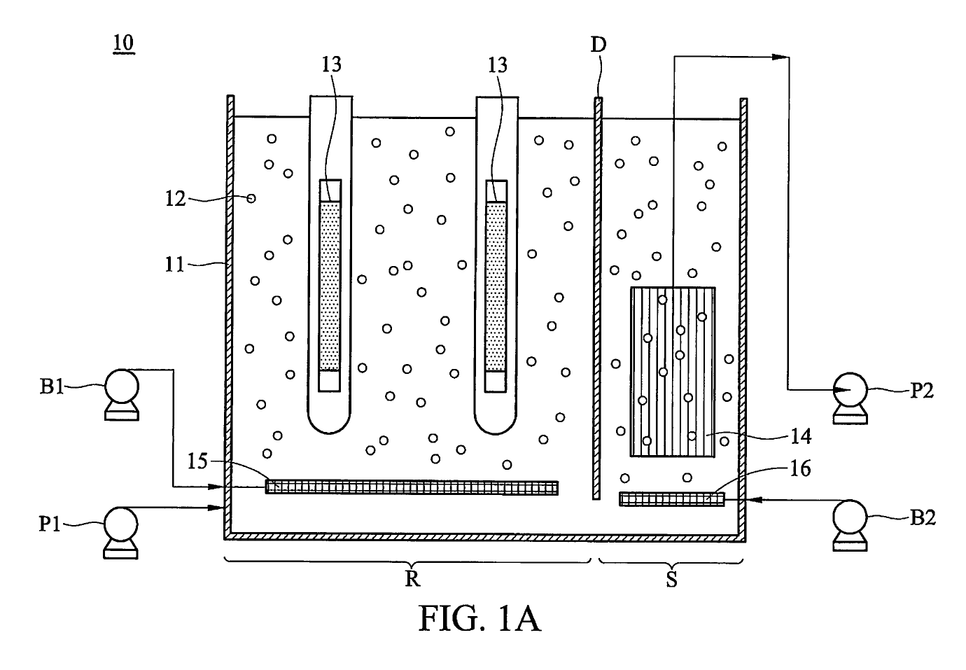

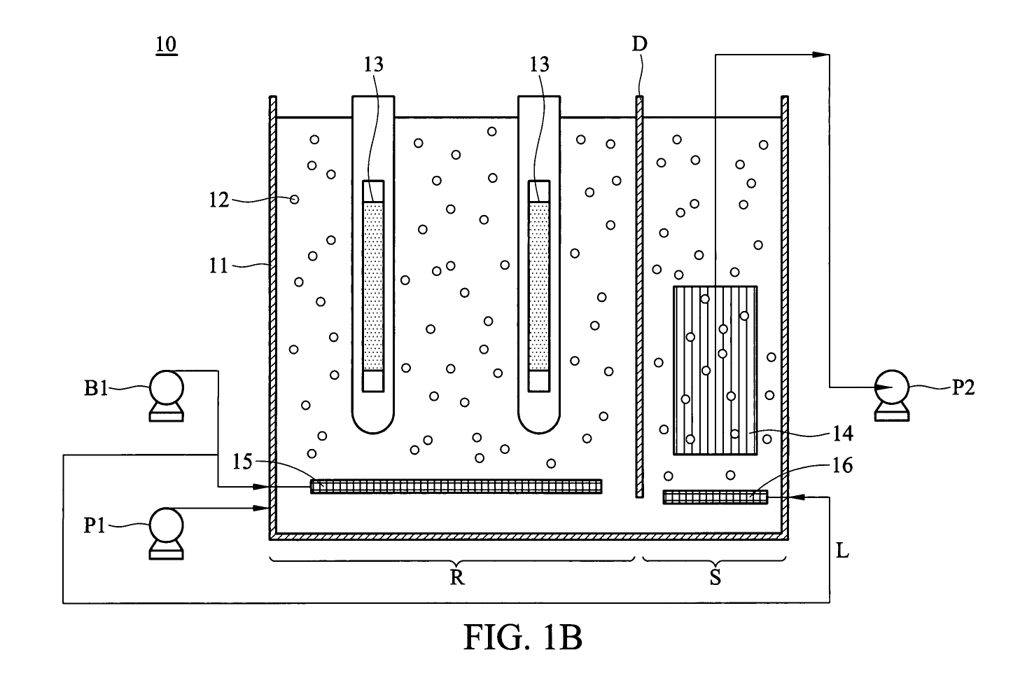

FIG. 1A is a schematic view of a first embodiment. The filtration device 10 of the embodiment comprises a tank 11, photocatalyst 12, two fluorescent tubes 13, a non-woven membrane module 14, a first air distributor 15, a second air distributor 16, an inflow pump P1, an outflow pump P2, a first blower B1, and a second blower B2, wherein the inflow pump P1 and the outflow pump P2 have the same flow rate.

The tank 11 is divided into a reacting section R and a separating section S by a divider D. A passage at the lower portion of the divider D communicates the reacting section R to the separating section S. The inflow pump P1 communicates with the reacting section R of the tank 11, pumping water to the tank 11.

The photocatalyst 12 is powdered TiO₂, added to the tank 11 and mixed with water. It should be noted that since the photocatalyst 12 of the embodiment is of extremely small particles, the photocatalyst 12 in all figures is not in proportion.

The fluorescent tubes 13 are disposed in the reacting section R, providing light to react with the photocatalyst 12, wherein the wavelength of light is between 250 and 450 nm. It should be noted that while there are two fluorescent tubes in the embodiment, it is not limited thereto.

The non-woven membrane module 14, comprised of a plurality of non woven membrane, is disposed in the separating section S and connects with the outflow pump P2. The non-woven membrane are of polymethyl methacrylate, polystyrene, polycarbonate, polyethylene terephthalate, polypropylene, polyethylene, 4-methylpentene, or a combination thereof. Additionally, the non-woven membrane have pore size with diameter between 0.03 and 30 μm.

The first air distributor 15 is disposed at the bottom of the reacting section R, communicating with the first blower B1. The first blower B1 provides air to the reacting section R, and air is diffused in the water by the first air distributor 15.

The second air distributor 16 is disposed at the bottom of the separating section S, communicating with the second blower B2. The second blower B2 provides air to the separating section S, and air is diffused in the water by the second air distributor 16.

In this embodiment, the second air distributor 16 communicates with the second blower B2, but it is not limited thereto. The first blower B1 can further comprise a manifold L (as shown in FIG. 1B). The second air distributor 16 communicates with the manifold L of the first blower B1, allowing the first blower B1 to provide air to the reacting section R. Air is diffused in the water by the second air distributor 16.

When the filtration device 10 is in operation, the first air distributor 15 diffuses air in the water, uniformly suspending the photocatalyst 12 in the water, such that the photocatalyst 12 can effectively contact pollutant in the water. The fluorescent tubes 13 provide light to react with the photocatalyst 12, and initiate oxidation and decompose pollutant thereto. The second air distributor 16 diffuses air in the water, producing shear force from cross-flow over the surface of the non-woven membrane. As a result, the photocatalyst 12 does not remain and clog the non-woven membrane, stablizing filtrating flux of the non-woven membrane module 14. Finally, the outflow pump P2 removes purified water through the non-woven membrane module 14. Because the non-woven membrane module 14 filters the photocatalyst 12, the photocatalyst 12 returns to the reacting section R to continue purifying water. Thus, the amount of photocatalyst 12 in the tank 11 remains stable.

Although purification rate increases with concentration of suspended photocatalyst, higher concentrations of suspended photocatalyst reduce the filtrating flux of the non-woven membrane module. Therefore, the invention provides another filtration device.

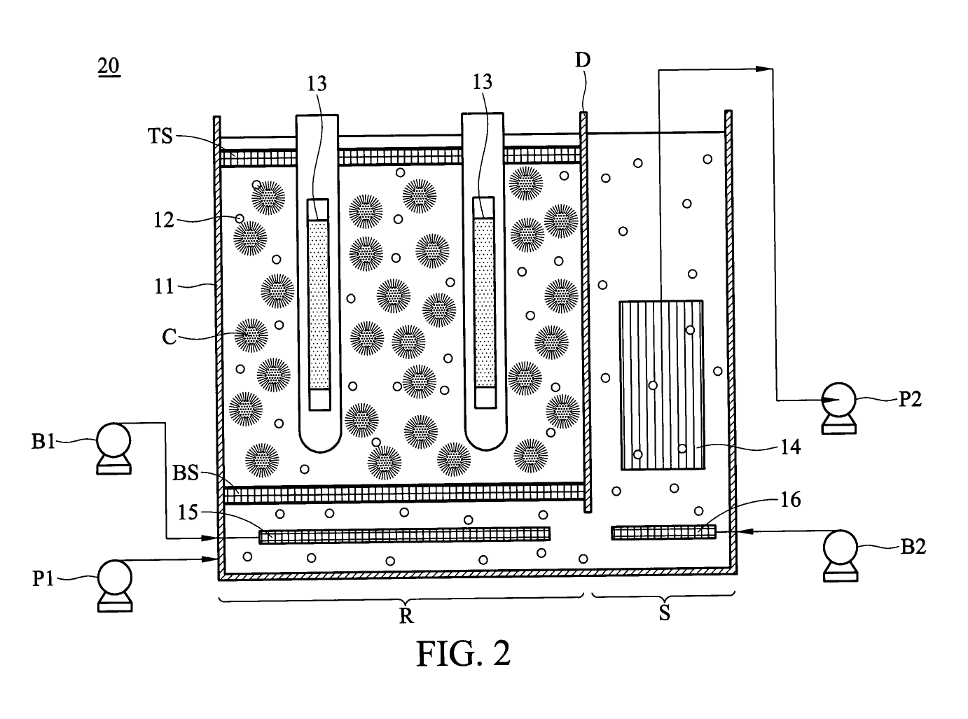

FIG. 2 is a schematic view of a second embodiment. The filtration device 20 of the embodiment comprises the same elements as the filtration device 10 of the first embodiment, and further comprises a plurality of carriers C, a top sieve TS, and a bottom sieve BS. The carriers C, pervious to light and of non-woven material, are disposed in the reacting section R. The top sieve TS is disposed at the top of the reacting section R, and the bottom sieve BS at the bottom of the reacting section R, such that the carriers C can move only between the top sieve TS and the bottom sieve BS.

It should be noted that the bottom sieve BS can be disposed in any position between the reacting section R and the separating section S, preventing the carriers C from flowing to the separating section S.

Non-woven material is porous and of fiber, so the carriers C, of non-woven material, can intercept and fix the suspended photocatalyst 12 therein, decreasing concentration of the suspended photocatalyst 12, and raising the filtration efficiency of the non-woven membrane module 14. Thus, filtrating flux is improved, and the operating pressure is lowered.

In this embodiment, the photocatalyst 12 can also be prefixed in the carriers C by chemical or physical means, and added to the reacting section R.

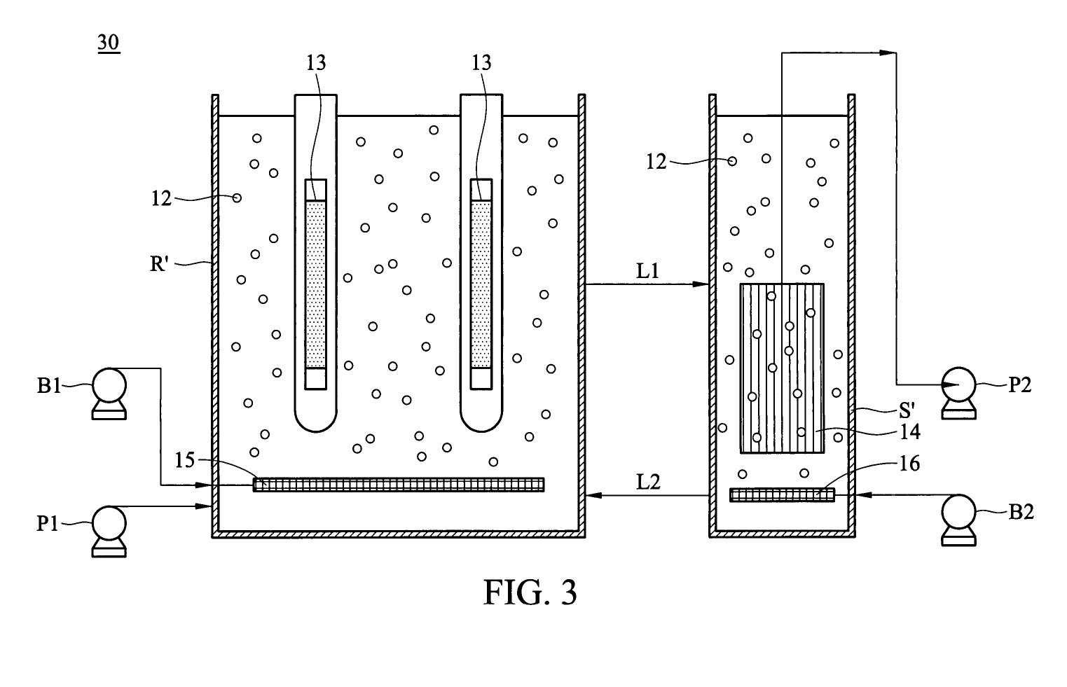

FIG. 3 is a schematic view of a third embodiment. The filtration device 30 of the embodiment comprises the same elements as the filtration device 10 of the first embodiment, differing only in that the separating section and the reacting section of the filtration device 30 are disposed separately as a first tank R′ and a second tank S′. The filtration device 30 further comprises a first tube L1 and a second tube L2, communicating the first tank R′ and the second tank S′. Water is purified in the first tank R′, and with the photocatalyst 12, transferred to the second tank S′ through the first tube L1. Water is then filtered through the non-woven membrane module 14, and removed by the outflow pump P2. The photocatalyst 12 in the second tank S′, blocked by the non-woven membrane module 14, is recycled to the first tank R′ through the second tube L2 for reuse.

The filtration device utilizes non-woven membrane to filter the photocatalyst. Solid particles in the water are removed by fabric filtration captured by lower pressure drop, improving filtration efficiency. Compared to micro-filtration membrane, fibers of the non-woven membrane interlace with each other, forming irregular but curved paths and holes. Not only is sieve mechanism provided, but also interception, inertial impaction, and Brownian diffusion are activated. The utilization of non-woven membrane in the filtration module allows the filtration device to operate at lower pressure, to effectively intercept solid particles, and lower material costs. In addition, the surface of the non-woven membrane can be backwashed, whereby fouling of the non-woven membrane is successfully controlled.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A filtration device, for purifying water, comprising:
a tank comprising a reacting section and a separating section;
photocatalyst added to water;
a light source, disposed in the reacting section, providing light to react with the photocatalyst and thereby decompose pollutants in the water; and
a non-woven membrane module, disposed in the separating section, intercepting the photocatalyst in the water, and producing purified water.

2. The filtration device as claimed in claim 1, further comprising a first air distributor, disposed in the reacting section, whereby air is diffused in the water by the first air distributor, uniformly suspending the photocatalyst.

3. The filtration device as claimed in claim 1, further comprising a second air distributor, disposed in the separating section, whereby air is diffused in the water by the second air distributor, maintaining filtrating flux of the non-woven membrane module.

4. The filtration device as claimed in claim 1, further comprising a mixer, disposed in the reacting section, uniformly suspending the photocatalyst.

5. The filtration device as claimed in claim 1, wherein the photocatalyst is TiO₂.

6. The filtration device as claimed in claim 1, further comprising non-woven carriers in the reacting section, intercepting the photocatalyst.

7. The filtration device as claimed in claim 1, further comprising a sieve, disposed between the reacting section and the separating section, preventing the carriers from entering the separating section.

8. The filtration device as claimed in claim 1, wherein the diameter of the carriers is between 2 mm to 20 mm.

9. The filtration device as claimed in claim 1, wherein the carriers are of polymethyl methacrylate, polystyrene, polycarbonate, polyethylene terephthalate, polypropylene, polyethylene, 4-methylpentene, or a combination thereof.

10. The filtration device as claimed in claim 1, wherein the light has a wavelength between 250 nm to 450 nm.

11. The filtration device as claimed in claim 1, wherein the non-woven membrane module comprises a plurality of non-woven membranes, with pore size of diameter between 0.03 μm -30 μm.

12. The filtration device as claimed in claim 1, wherein the non-woven membrane module comprises a plurality of non-woven membranes, and the non-woven membranes are of polymethyl methacrylate, polystyrene, polycarbonate, polyethylene terephthalate, polypropylene, polyethylene, 4-methylpentene, or a combination thereof.

13. A filtration device, for purifying water, comprising:
a first tank;
photocatalyst added to the first tank;
a light source, disposed in the first tank, providing light to react with the photocatalyst and thereby decompose pollutants in the water;
a second tank, communicating with the first tank, receiving water from the first tank; and
a non-woven membrane module, disposed in the second tank, intercepting the photocatalyst in the water, producing purified water.

14. The filtration device as claimed in claim 13, further comprising a first air distributor, disposed in the first tank, whereby air is diffused in the water by the first air distributor, uniformly suspending the photocatalyst in the water.

15. The filtration device as claimed in claim 13, further comprising a second air distributor, disposed in the second tank, whereby air is diffused in the water by the second air distributor, maintaining filtrating flux of the non-woven membrane module.

16. The filtration device as claimed in claim 13, further comprising a mixer, disposed in the first tank, uniformly suspending the photocatalyst in the water.

17. The filtration device as claimed in claim 13, further comprising a second air distributor, disposed in the second tank, whereby air is diffused in the water, maintaining filtrating flux of the non-woven membrane module.

18. The filtration device as claimed in claim 13, wherein the light has a wavelength between 250 nm and 450 nm.

19. The filtration device as claimed in claim 13, wherein the non-woven membrane module comprises a plurality of non-woven membranes, with pore size of diameter between 0.03 μm and 30 μm.

20. The filtration device as claimed in claim 13, wherein the non-woven membrane module comprises a plurality of non-woven membranes, and the non-woven membranes are of polymethyl methacrylate, polystyrene, polycarbonate, polyethylene terephthalate, polypropylene, polyethylene, 4-methylpentene, or a combination thereof.
